(19) United States
(12) Patent Application Publication
(10) Pub. No.: US 2025/0222775 A1
(43) Pub. Date: Jul. 10, 2025

(54) A POWER SYSTEM FOR DRIVING AN ELECTRIC MOTOR

(71) Applicant: Lukasz SZYMANSKI, Lodz (PL)

(72) Inventor: Bruce BINKLEY, Miloslaw (PL)

(21) Appl. No.: 18/863,138

(22) PCT Filed: Sep. 5, 2022
(86) PCT No.: PCT/EP2022/074593

§ 371 Date: Nov. 5, 2024

(30) Foreign Application Priority Data
Sep. 10, 2021 (EP) 21461587.4

(51) Int. Cl. B60L 3/00; B60L 15/04; B60L 15/20; B60L 50/52; B60L 50/60; B60L 58/19; B60L 58/22; H01M 10/42; H01M 50/509; H02J 7/00

(52) U.S. Cl. CPC B60L 3/0046; B60L 15/04; B60L 15/20; B60L 50/52; B60L 50/60; B60L 58/19; B60L 58/22; H01M 10/425; H01M 50/509; H02J 7/0029; B60L 2240/547; H01M 2010/4271; H01M 2220/20

(57) ABSTRACT

A power system for driving a direct current electric motor that is controlled by a driving voltage. The power system includes a plurality of cell modules, each cell module having one or more cells and a plurality of connectors for connecting the cell modules to form a configurable battery to generate the driving voltage. The connectors connect the cell modules into configurable clusters. A voltage level controller controls the configuration of the configurable clusters to provide the driving voltage at one of a set of selectable voltage levels, wherein for each voltage level of said set a share of a current drawn from each of the cell modules with respect to a total current drawn from the configurable battery is lower than for each higher voltage level of said set.

### TECHNICAL FIELD

The present invention relates to a power system for driving an electric motor.

### BACKGROUND

Vehicles driven by electric motors typically comprise a battery having a plurality of serially connected cells or serially connected modules of parallel-connected cells. The series connection is not configurable. Such battery is usually connected to a Pulse Width Modulation (PWM) controller that regulates the value of effective voltage by changing a width of an impulse (without changing the actual value of the voltage provided from the battery) that is input to a three-phase direct current (DC) voltage converter and next to a brushless DC motor (BLDC). Furthermore, such battery typically comprises a Battery Management System (BMS) of a nS-BMS type (wherein n is the number of cells or modules that are connected in a series forming the battery). The nS-BMS protects the individual cells or modules within the series from operating outside of safe operating range, i.e., overcharging or discharging beyond a predetermined upmost and lowermost voltage value, overheating by overloading, etc.

The solution described above has several disadvantages. First, it dissipates relatively large amounts of energy due to heating of the PWM converter, due to its limited efficiency, which decreases along with decrease of current, which results in a very low efficiency when the vehicle moves with minimal speed. In addition, this also requires provision of extra energy to power a cooling system to cool the PWM converter.

Moreover, the battery itself consumes some energy due to heating of the battery cells. The increase of energy dissipation caused by limited efficiency of the PWM converter causes additional change of electric energy into heat within the battery. Consequently, more energy is consumed without even exiting the battery end, again this requires increased cooling of the battery, therefore more energy is required (when using a battery temperature control system, which is already employed in most electric vehicles).

Moreover, a power system having all battery cells or cell modules connected in series is as such prone to failure even if one serially-connected cell or cell module fails—if one element of the serial chain fails (i.e., breaks down or runs out of energy earlier than others), the whole series is broken, and it is no longer possible to deliver energy to the electric motor. This causes limitation of operational time (and consequently, limitation of autonomy of the vehicle) until the one and only Battery Monitoring System within the battery decides to turn off the whole battery due to detecting low charge level at the weakest cell or the weakest cell module.

There are also known attempts to design a configurable battery that comprises a plurality of cells interconnected by switches, wherein the output voltage of the battery can be adjusted by adjusting a configuration of the switches, in order to configure the cells in a series connection, a parallel connection or a mixed series/parallel connection. Such systems are for example disclosed in the following prior art publications: US2012013180, WO2020224951, U.S. Pat. No. 8,957,610 or US2012119573. The solutions presented therein have a major drawback related to a lack of possibility of controlling whether the cells are correctly charged or discharged. This is because a typical nS-BMS as described above with respect to a battery comprising a plurality of cells connected in series is not capable of protecting cells connected in another configuration, such as a switchable series/parallel connection. Therefore, the solutions presented in the above-mentioned documents can only be used for cells that are immune to overcharging or over discharging, for example lead-acid cells that when overcharged simply discharge hydrogen or nickel cadmium or nickel hydride batteries that when overcharged simply dissipate surplus of energy in the form of heat. In contrast, such solutions are not appropriate for cells that are sensitive to the limits of charging and discharging voltages, such as all the types of lithium batteries, which may get damaged if their voltage drops below or rises above a safety threshold level (which can be dangerous).

US2012013180 discloses a battery control apparatus comprising a battery circuit in which a plurality of batteries are connected to each other; a plurality of first switches that switch whether the batteries are connected in series or connected in parallel; a voltage detecting section that detects a maximum voltage output by the battery circuit; and a switch control section that, when the maximum voltage of the battery circuit occurring when the batteries are connected in parallel is less than or equal to a first threshold value, controls the first switches to connect at least a portion of the batteries in series. The system contains a voltage detecting section that detects an output voltage of the overall battery circuit, but not of individual batteries. Therefore, such system may operate only with battery types that do not need a battery management system.

WO2020224951 discloses a system for supplying AC driving voltages to a plurality of electric motors. A variable voltage source is associated with each phase of a main motor. Said variable voltage sources are controlled to provide a voltage corresponding to a voltage ensuring that an effective voltage corresponding the set value of the corresponding phase voltage of the main electric motor is applied to each of its phases. The variable voltage source comprises a plurality of module switches and storage elements that can be connected in series or another configuration. It is not described whether there are any means for controlling the charging voltage level, therefore such system may operate only with battery types that do not need a battery management system.

U.S. Pat. No. 8,957,610 discloses a multi-port reconfigurable battery, comprising at least one bank of: a statically joined plurality of series connected battery cells; a plurality of ports, each port comprising: at least one processor controlled switch electrically connected between said first voltage pole of each of said battery cells and a first electrical output connection, and at least one processor controlled switch electrically connected between said second voltage pole of each of said battery cells and a second electrical output connection; wherein said processor controlled switches are adapted to electrically reconfigure said battery cells by coupling a first voltage pole of one of said battery cells to said first electrical output connection and a second voltage pole of one of said battery cells to said second electrical output connection to provide a reconfigurable battery output voltage between said first and second electrical output connections. It is not described whether there are any means for controlling the charging voltage level, therefore such system may operate only with battery types that do not need a battery management system.

US2012119573 discloses an apparatus comprising a plurality of reconfigurable interconnected energy sources (e.g., batteries), a controller that receives energy from the plurality of energy sources and regulates output energy; and a device for converting the output energy of the controller into one of a force or a rate. A switch is configured to switch the plurality of energy sources between one of a series and a parallel configuration only, therefore only two output voltage levels can be achieved. Moreover, it is not described whether there are any means for controlling the charging voltage level, therefore such system may operate only with battery types that do not need a battery management system.

To sum up, the prior art comprises two types of configurable batteries:
batteries comprising a plurality of cells connected in series with a nS-BMS system to keep the voltage levels of individual cells within allowable limits;
batteries comprising a plurality of cells which can be connected into different configurations, which can be used only with cells that are immune to overcharging and over discharging, which don't need a battery management system.

### SUMMARY OF THE INVENTION

There is a need to provide a solution for powering electric motors that will reduce at least some of the problems discussed above.

In one aspect, the invention relates to a power system for driving a direct current (DC) electric motor that is controlled by a driving voltage, the power system comprising: a plurality of cell modules, each module comprising one or more cells and a dedicated battery management system (BMS) configured to protect said one or more cells of that cell module from operating outside a safe operating range. A plurality of connectors are provided for connecting the cell modules to form a configurable battery to generate the driving voltage. The connectors are configured to connect the cell modules into configurable clusters. A voltage level controller is configured to control the configuration of the configurable clusters at the individual nS BMS levels to provide the driving voltage at one of a set of selectable voltage levels, wherein for each voltage level of said set a ratio of a current drawn from each of the cell modules to a total current drawn from the configurable battery is lower than for each higher voltage level of said set. So, basically, the present invention does not involve switching cells or clusters of cells but switching multiple BMSes wherein one BMS protects one cell or one cluster of cells.

Such power system is particularly useful for driving electric motors of electric-powered vehicles. It is applicable to any type of direct current (DC) electric motor that is controlled by a driving voltage, such as a brushed DC electric motor or a brushless DC electric motor (BLDC).

Each of the cell modules comprises a dedicated battery management system. If the cell modules contain a single set of cells all connected in parallel, the battery management system can be called a 1S-BMS (i.e., related to a single-element series). If the cell modules contain n serially connected sets of cells connected in parallel, the battery management system can be called an nS-BMS (e.g., if there are three serially connected sets of cells connected in parallel, this can be called a 3S-BMS etc.). The BMS is configured to protect the cells of the module from operating outside a safe operating range, i.e., charging or discharging beyond a predetermined upmost and lowermost voltage value.

Use of a dedicated BMS for each cell module allows to use the power system with batteries that are sensitive to overcharging or over discharging, such as lithium Li-Ion batteries, Li—Fe—PO₄ batteries, etc. The present system employs a novel idea of providing a dedicated BMS to each cell or to each cell module, in contrast to prior art solutions wherein a single BMS was used for the whole power system, thereby not allowing to re-configure cell connections.

Various types of known BMS solutions can be used, including these that have passive and active cells balancing solutions.

If two or more cell modules, each having the BMS, are connected in parallel, they will equalize their charges. Therefore, in particular when the vehicle drives with a low speed at traffic or stops at a red light or is parked for a longer period of time, the electric charge of all cell modules will be actively balanced. Consequently, when subsequently the vehicle is operated at full power and all cell modules are connected in series, the previous balancing of charges between the cells will allow the vehicle to operate longer, as the weakest cell module has been charged during the balancing. When the vehicle operates not necessarily at the lowest speed, but at a speed that is less than the highest than the corresponding clusters are being actively balanced.

This is an alternative way of controlling the driving voltage as compared to typical systems. In typical systems, all cells are connected in a static series to provide a constant battery voltage and a PWM controller provides this real voltage as the driving voltage in form of pulses of controllable width, producing in this way apparent voltage of less value. In contrast, in the system of this invention, the driving voltage is controlled by re-configuring the connection of cell modules into clusters such as to provide output of real voltage at different levels. Where the already decreased current is further more split between in parallel connected clusters or modules. This in effect reduces the need for PWM switching.

The heating of the system is significantly reduced. In the typical PWM-controlled systems, full battery current is drawn from all cells. In contrast, in the system of the invention, for voltage levels lower than the highest voltage level, only a fraction of the full battery current is drawn from each cell (the lower the driving voltage, the smaller fraction of the current drawn), and therefore much less heat is dissipated at each cell.

Such system is less prone to failure, because for lower voltage levels the current that needs to be drawn from each cell module is lower. And even if one module fails while connected in parallel, the battery will still perform. In contrast, for a typical PWM controlled system, all cells are always subject to the full current load and therefore if one module fails, the whole battery fails.

Consequently, the proposed power system may deliver to the electric motor a higher percentage of power stored in the cells (in view of less power dissipated for heating, inside the cells as well as no power dissipated for heating by previously in use PWM, extended operation and also will reduce the energy needed for cooling and in a situation if even some cells are damaged or decreased parameters of safe operating range, more efficient use of all cells) than a conventional PWM controlled system, therefore the electric motor can do more work utilizing the power stored in the battery. Consequently, if the electric motor is mounted in a vehicle, this may significantly increase the driving range of the vehicle.

The connectors can be configured to connect the cell modules into one or more clusters connected in parallel, wherein each cluster comprises one or more cell modules connected in series and for each voltage level of said set the number of cell modules in each cluster is lower than for each higher voltage level of said set.

For a driving voltage lower than the highest possible voltage, at least two clusters must be connected in parallel. In this system, it is enough for at least one cluster to function properly in order for the battery to continue its work.

The connectors can be configured to connect the cell modules into one or more clusters connected in series, wherein each cluster comprises one or more cell modules connected in parallel and for each voltage level of said set the number of cell modules in each cluster is higher than for each higher voltage level of said set.

For a driving voltage lower than the highest possible voltage, each cluster may contain at least two cells or cell modules. Such system is protected against failure of any one or more of the cell modules—it is enough if at least one cell module in each module operates correctly.

At least a majority of all the cell modules can be always actively connected within the clusters that provide the driving voltage. This allows to efficiently distribute the load evenly across the cell modules and therefore extend their lifetime. In other preferable embodiments, not all but most cells are always actively connected—for example, more than 50% or more than 60% or more than 70% or more than 80% or more than 90% or 100% of the cell modules are always actively connected. By the term “actively connected” it is meant that the modules are operable and deliver power to the battery.

The power system may further comprise a PWM controller for providing the driving voltage to the motor as a series of controlled-width pulses having an amplitude according to the output voltage level. This allows for smooth control of the electric motor despite the stepping of levels of the driving voltages. The PWM controller switches the real voltage limited to the apparent desired voltage, which does not have to be the highest achievable voltage level. Consequently, voltages of lower level are switched as compared to a typical PWM controlled system (wherein the highest voltage is always switched).

The power system may be configured to supply the driving voltage of the highest level to two motors connected in parallel and to supply the driving voltage of half of the highest level or less to two motors connected in series. When two motors are connected in series, each powering the wheel on the opposite side and each supplied with half of its nominal voltage, this provides a functionality of an electric differential and the need of use of a mechanical differential (which is bulky and heavy) is eliminated.

In another aspect the invention relates to a powertrain comprising the power system as described herein, connected to the electric motor and a drivetrain for delivering mechanical power from the electric motor to wheels.

The powertrain may comprise a pair of electric motors configured to drive a pair of wheels of a vehicle axis and a differential controller configured to be set: in a first configuration to connect the electric motors in series to the voltage output from the power system to provide a mechanical differential functionality; and in a second configuration to connect the electric motors in parallel to the voltage output from the power system to provide an effect similar to limited slip differential functionality.

The drivetrain may comprise a CVT transmission. This allows for smooth control of speed even if the power system provides stepped voltage to the motor, without the need to use PWM.

These and other features, aspects and advantages of the invention will become better understood with reference to the following drawings, descriptions and claims.

### BRIEF DESCRIPTION OF DRAWINGS

Various embodiments are herein described, by way of example only, with reference to the accompanying drawings, wherein:

FIG. 1 shows an overall diagram of a first embodiment of a system for driving a direct current motor;

FIG. 2A shows a first variant of a first example embodiment of a topology of a configurable battery for providing the driving voltage at different voltage levels;

FIG. 2B shows a second variant of the first example embodiment of a topology of a configurable battery for providing the driving voltage at different voltage levels;

FIGS. 3A-3D show a first example of sets of configurations of connectors of the topology of the first embodiment of the configurable battery of FIG. 2A to achieve different voltage levels;

FIGS. 4A-4D show a second example of sets of configurations of connectors of the topology of the first embodiment of the configurable battery of FIG. 2A to achieve different voltage levels;

FIG. 5 shows a second example embodiment of a topology of a configurable battery for providing the driving voltage at different voltage levels;

FIGS. 6A-6C show a first example of sets of configurations of connectors of the topology of the second embodiment of the configurable battery of FIG. 5 to achieve different voltage levels;

FIGS. 7A-7C show a second example of sets of configurations of connectors of the topology of the second embodiment of the configurable battery of FIG. 5 to achieve different voltage levels;

FIG. 8 shows a third example embodiment of a fragment of a topology of a configurable battery for providing the driving voltage at different voltage levels;

FIG. 9 shows an overall diagram of a second embodiment of a system for driving a direct current motor;

FIG. 10 shows an overall diagram of a third embodiment of a system for driving a direct current motor.

FIG. 11 shows an embodiment of application of the power system of FIG. 1.

### DETAILED DESCRIPTION

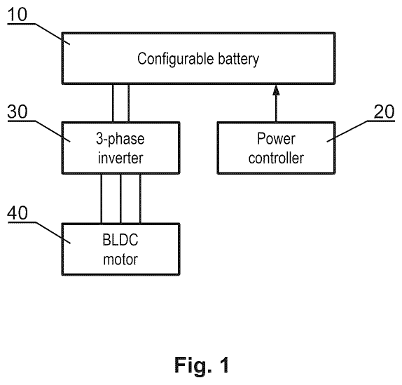

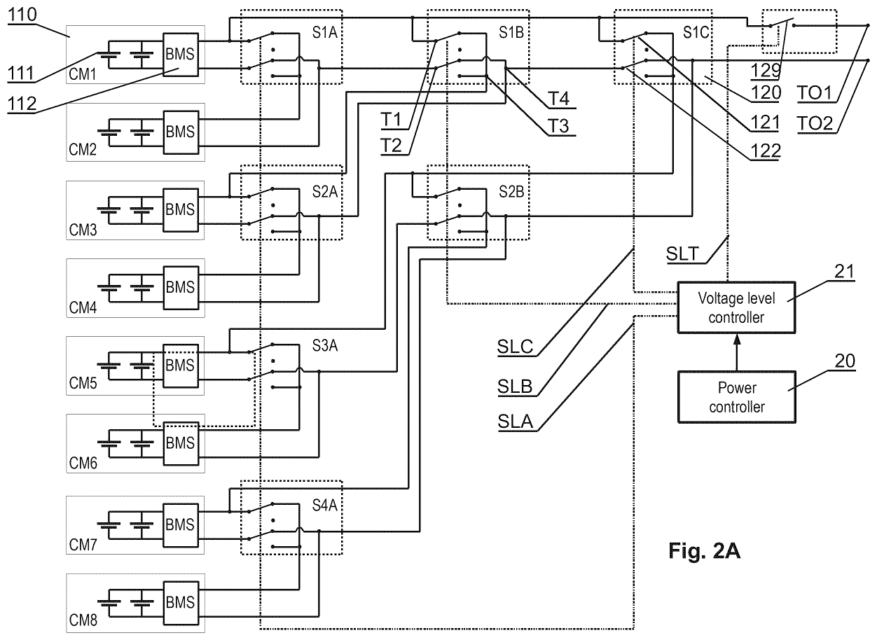

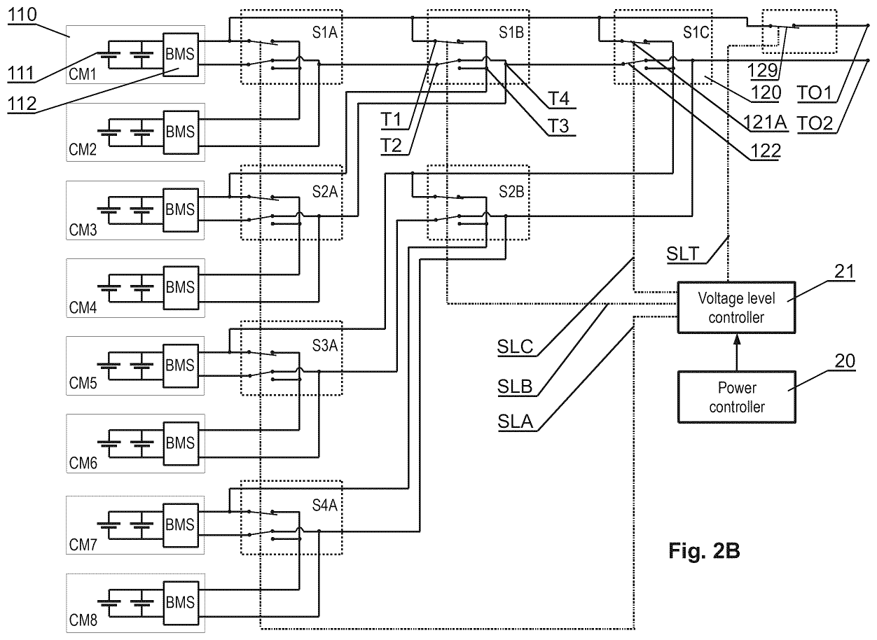

The following detailed description is of the best currently contemplated modes of carrying out the invention. The description is not to be taken in a limiting sense but is made merely for the purpose of illustrating the general principles of the invention. FIG. 1 shows an overall diagram of a first embodiment of a system for driving a direct current motor. A configurable battery 10 provides a driving voltage of different levels that depend on a power controller 20 which receives a control signal from a controller of the device or machine where the power system is installed. For example, if the power system is installed in a vehicle, the power controller 20 may be controlled by a gas pedal or a cruise control system of the vehicle. The driving voltage is input to a 3-phase inverter 30 that drives a direct current (DC) electric motor 40, such as a brushless direct current (BLDC) motor. The driving voltage is therefore the effective voltage that drives the DC electric motor. The configurable battery 10 is configured to provide the driving voltage at different voltage levels from cell modules connected into configurable clusters. For example, the configurable battery 10 can provide voltage supply at 8 different levels, from a topology such as shown in FIGS. 2A and 2B, wherein individual cell modules provide 3.7V output and there are 8 voltage levels (level 1=3.7V, level 2=7.4 V, level 3=14.8 V, level 4=29.6 V, level 5=59.2 V, level 6=118.4 V, level 7=236.8 V, level 8=473.6 V). This way, the electric motor 40 can be driven by 8 different voltages.

FIG. 2A shows a first variant of a first example embodiment of a topology of a configurable battery for providing the driving voltage at different voltage levels; The configurable battery 10 of this embodiment comprises eight cell modules 110 (CM1-CM8), each cell module 110 comprising two cells 111 connected in parallel that may be controlled by a battery management system (BMS) 112. The BMS 112 is configured to protect said one or more cells from operating outside its safe operating range if the cells require such protection—this is useful in particular for lithium cells. The cell modules 110 are connected to a cascade of switching modules 120 (S1A-S4A, S1B-S2B, S1C), wherein each of the switching modules comprises a pair of switches 121, 122, and to a terminating switch 129. The switches 121, 122, 129 form a role of connectors that connect the cell modules 110 to form a battery to generate the driving voltage. The position of the switches 121, 122, 129 is controlled by a voltage level controller 21 that operates in response to the signal from the power controller 20 to provide the driving voltage at one of a set of selectable four voltage levels.

The switching modules 120 have four terminals T1-T4. The switching modules 120 are designed to selectably connect two pairs of input terminals (the first pair: T1, T2 and the second pair: T3, T4) into a series connection or a parallel connection, such as to provide an output terminal pair. The switches 121, 122 are Single Pole Double Throw (SPDT) switches, i.e., they have one input terminal and two output terminals. For the first switch 121, its input terminal is connected to the first terminal T1 of the first terminals pair, its first output terminal is connected to the first terminal T3 of the second terminals pair, and its second output terminal is connected to an isolated point. For the second switch 122, its input terminal is connected to the second terminal T2 of the first terminals pair, its first output terminal is connected to the second terminal T4 of the second terminals pair, and its second output terminal is connected to the first terminal T3 of the second terminals pair. When the switches 121, 122 are both set into their first position (i.e., connecting the input to the first output), the first terminals pair T1, T2 is connected in parallel with the second terminals pair T3, T4. When the switches 121, 122 are both set into their second position (i.e., connecting the input to the second output), the first terminals pair T1, T2 is connected in series with the second terminals pair T3, T4.

The switching modules 120 can be also considered to be a double pole double throw (DPDT) switch.

Each switching module S1A-S4A, S1B-S2B, S1C is therefore connected to two input terminal pairs T1, T2; T3, T4 and provides an output terminal pair T1, T4. The switching modules are connected in a cascade, wherein the first level A of four switches S1A-S4A is connected to eight cell modules CM1-CM8 and provides four output pairs, the second level B of two switches S1B-S2B is connected to the four output pairs of the first level A and provides two output pairs, the third level C of one switch S1C is connected to the two output pairs of the second level B and provides one output pair.

All switches 121, 122 within all modules 120 of the same level A-C are at a given time set to the same position. The position of the switches 121, 122 of modules 120 within a particular level A, B, C is controlled by a corresponding control signal SLA, SLB, SLC from the voltage level controller 21. The position of the terminating switch 129 is controlled by a control signal SLT.

The switch 129 is an SPST switch, it has its input terminal connected to a first output terminal of the output pair of the third level C and its output terminal providing an output voltage in a closed position.

The output of the configurable battery is therefore provided as a pair of terminals, wherein the first output terminal TO1 is connected to the output terminal of the switch 129 and the second output terminal TO2 is connected to the second output terminal of the third level C of switch modules.

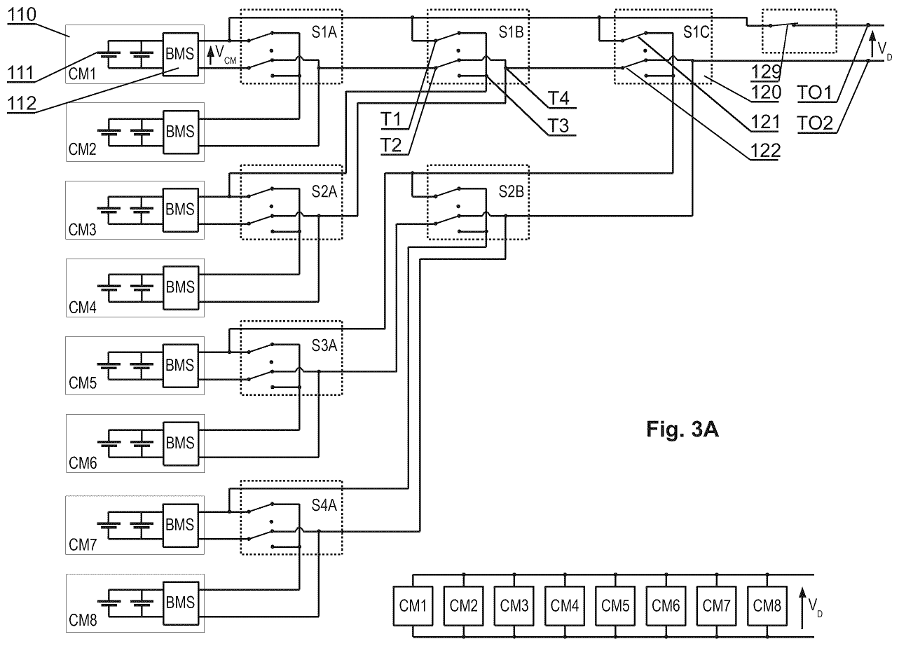

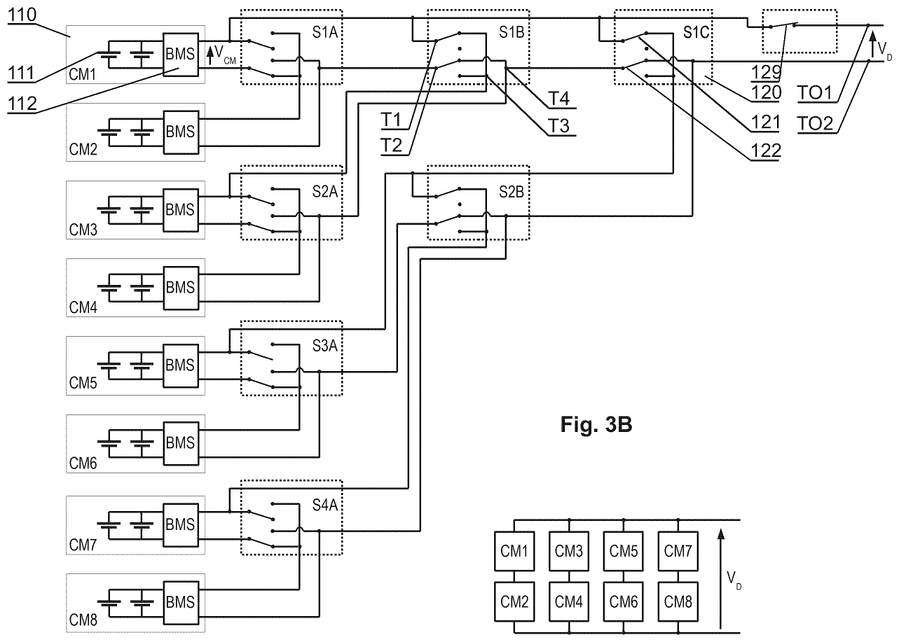

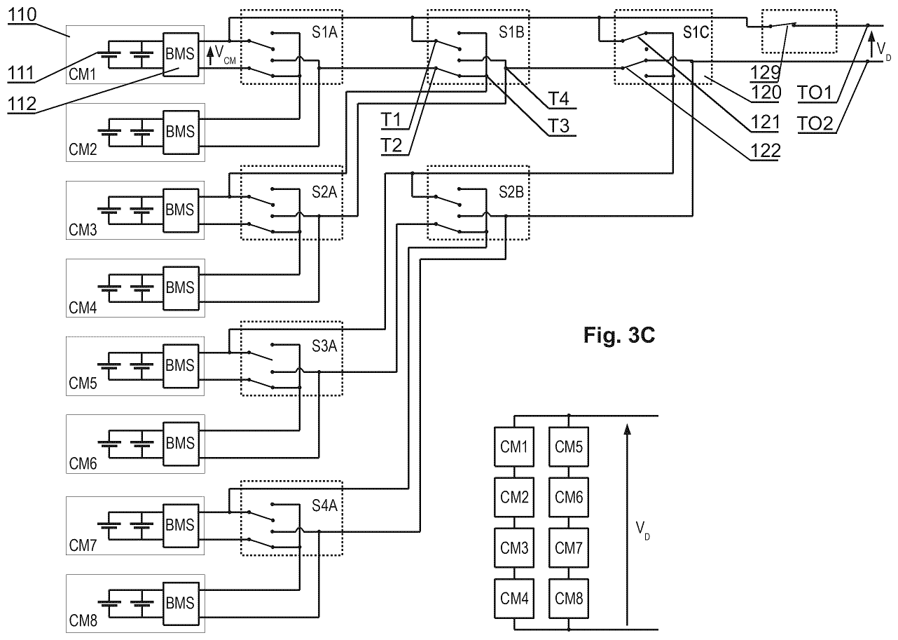

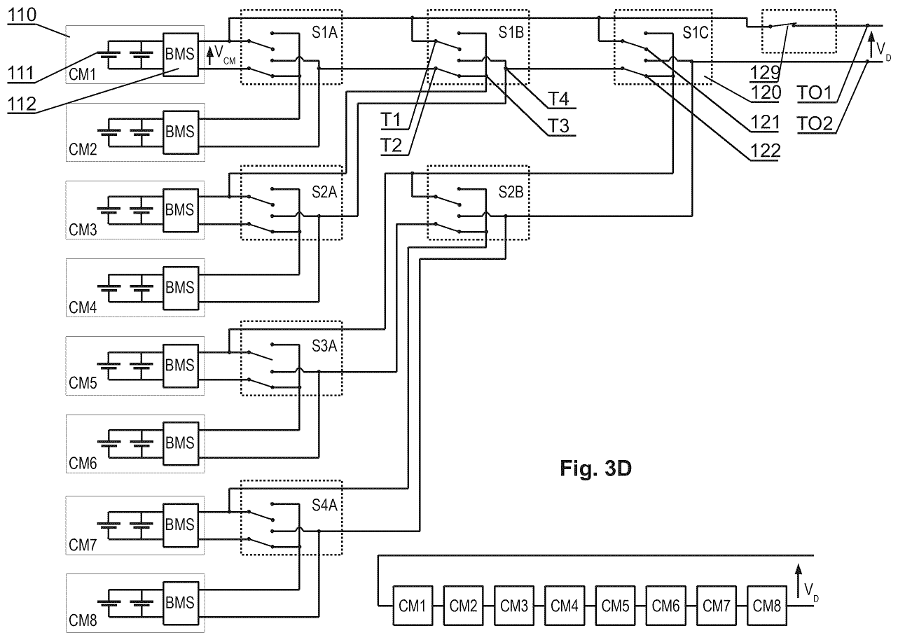

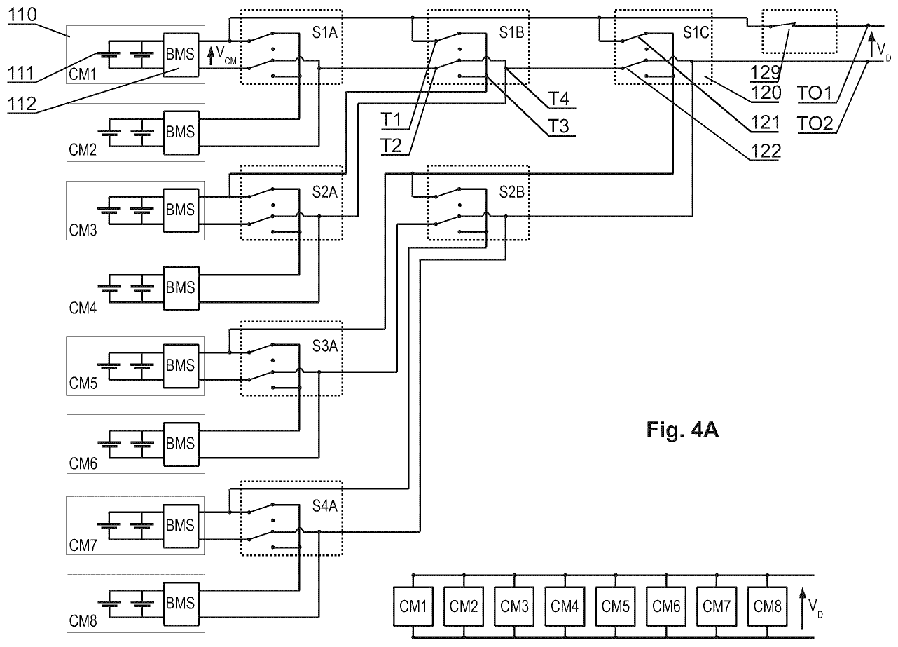

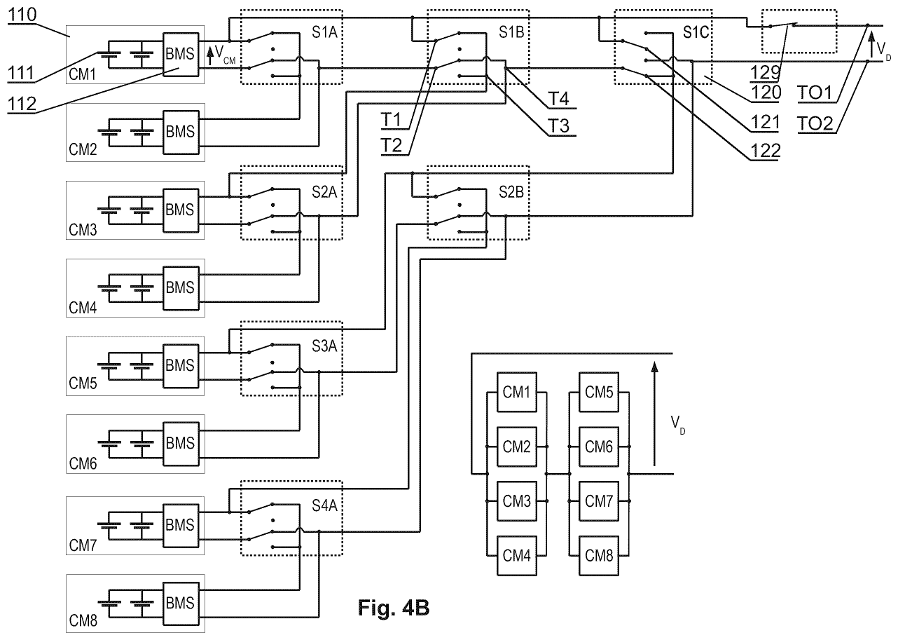

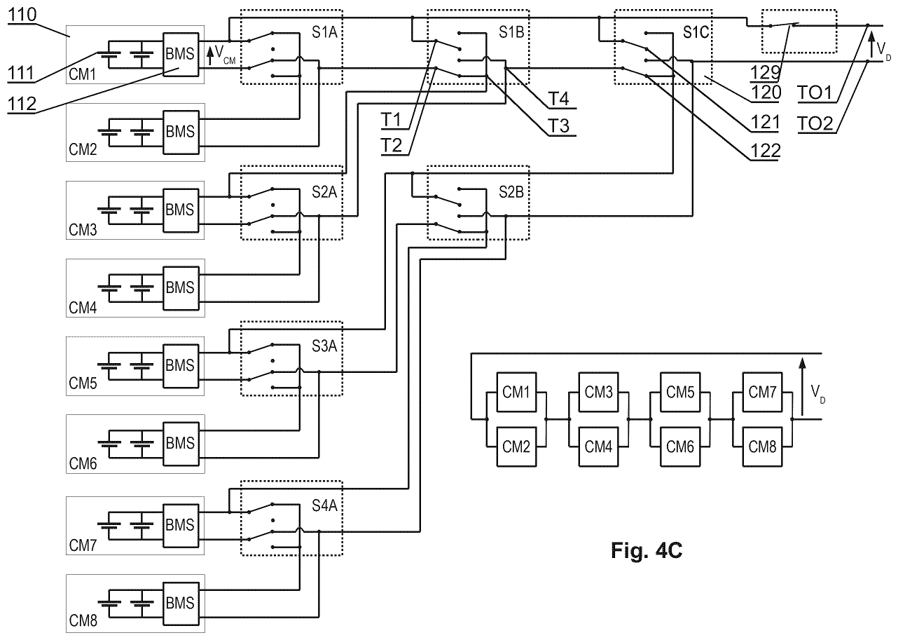

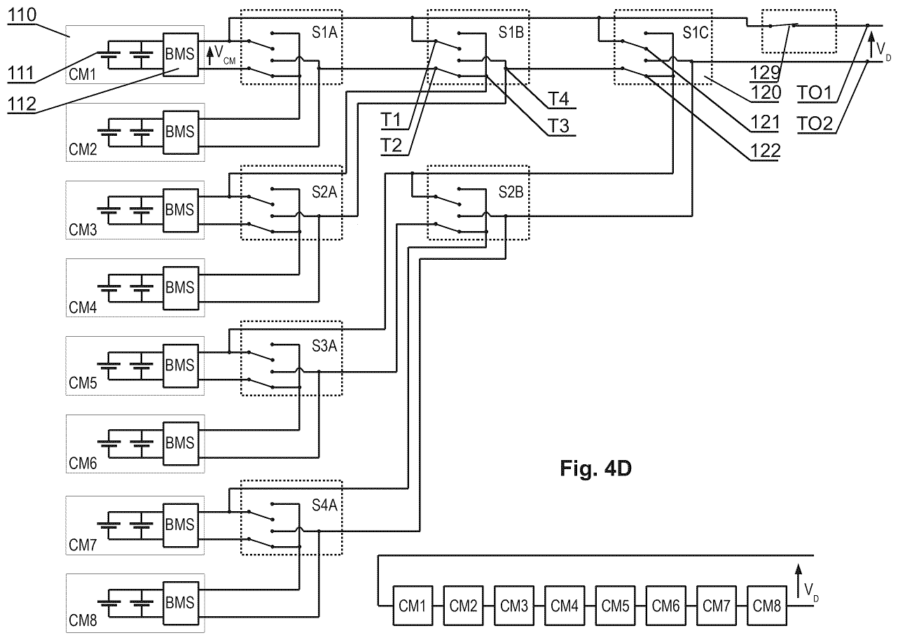

Depending on the desired configuration of clusters, the topology of FIG. 2A can be setup into different configurations, some examples of which are provided on FIGS. 3A-3D and 4A-4D.

Assume each cell module provides the same output voltage designated as V_{CM}.

In the example of FIGS. 3A-3D, the switches at levels A-C are switched in the order A->B->C, which gives the following configurations.

First, in order to switch on the power supply and provide the lowest voltage level, all switches 121-122 of all switching modules are set to the first position and the switch 129 is set to the closed position, as shown in FIG. 3A (when the switch 129 would be set to the open position, there would be no output voltage provided). In such configuration, all cell modules CM1-CM8 are connected in parallel and the driving voltage V_{D}=V_{CM}. In other words, the cell modules CM1-CM8 form eight clusters connected in parallel, each cluster containing a single cell module. The electric current drawn from each cell module CM1-CM8 is ⅛ of the total current drawn from the battery.

Next, in order to provide a higher voltage level, the switching modules S1A-S4A of level A are switched to the second position, as shown in FIG. 3B. In such configuration, the cell modules CM1-CM8 form four clusters connected in parallel, wherein each cluster contains two cell modules connected in series: CM1, CM2; CM3, CM4; CM5, CM6; CM7, CM8. The driving voltage V_{D}=2*V_{CM}. The electric current drawn from each cell module CM1-CM8 is ¼ of the total current drawn from the battery.

Next, in order to provide a higher voltage level, the switching modules S1B-S2B of level B are switched to the second position, as shown in FIG. 3C. In such configuration, the cell modules CM1-CM8 form two clusters connected in parallel, wherein each cluster contains four cell modules connected in series: CM1, CM2, CM3, CM4; CM5, CM6, CM7, CM8. The driving voltage V_{D}=4*V_{CM}. The electric current drawn from each cell module CM1-CM8 is ½ of the total current drawn from the battery.

Next, in order to provide the highest voltage level, the switching module S1C of level C is switched to the second position, as shown in FIG. 3D. In such configuration, the cell modules CM1-CM8 form a single cluster that contains eight cell modules connected in series: CM1-CM8. The driving voltage V_{D}=8*V_{CM}. The electric current drawn from each cell module CM1-CM8 is the total current drawn from the battery.

In the example of FIGS. 4A-4D, the switches at levels A-C are switched in the order C->B->A, which gives the following configurations.

First, in order to switch on the power supply and provide the lowest voltage level, all switches 121-122 of all switching modules are set to the first position and the switch 129 is set to the closed position, as shown in FIG. 4A (when the switch 129 would be set to the open position, there would be no output voltage provided). In such configuration, all cell modules CM1-CM8 are connected in parallel and the driving voltage V_{D}=V_{CM}. In other words, the cell modules CM1-CM8 form a single cluster of eight parallel connected cell modules. The electric current drawn from each cell module CM1-CM8 is ⅛ of the total current drawn from the battery.

Next, in order to provide a higher voltage level, the switching module S1C of level C is switched to the second position, as shown in FIG. 4B. In such configuration, the cell modules CM1-CM8 form two clusters connected in series, wherein each cluster contains four cell modules connected in parallel: CM1, CM2, CM3, CM4; CM5, CM6, CM7, CM8. The driving voltage V_{D}=2*V_{CM}. The electric current drawn from each cell module CM1-CM8 is ¼ of the total current drawn from the battery.

Next, in order to provide a higher voltage level, the switching modules S1B-S2B of level B are switched to the second position, as shown in FIG. 4C. In such configuration, the cell modules CM1-CM8 form four clusters connected in series, wherein each cluster contains two cell modules connected in parallel: CM1, CM2; CM3, CM4; CM5, CM6; CM7, CM8. The driving voltage V_{D}=4*V_{CM}. The electric current drawn from each cell module CM1-CM8 is ½ of the total current drawn from the battery.

Next, in order to provide the highest voltage level, the switching modules S1A-S4A of level A are switched to the second position, as shown in FIG. 4D. In such configuration, the cell modules CM1-CM8 form eight clusters connected in series, wherein each cluster contains a single module. The driving voltage V_{D}=8*V_{CM}. The electric current drawn from each cell module CM1-CM8 is the total current drawn from the battery.

The configurable battery of the topology of FIG. 2A can provide four different voltage output levels from eight cell modules.

In general, the system of the topology of FIG. 2A can provide n+1 different voltage output levels from 2ⁿ cell modules by using n levels of switching modules and the terminating switch, wherein n=3 in this example. The first level A of switching modules contains 2ⁿ⁻¹ of switching modules to which all cell modules are connected, the second level B of switching modules contains 2ⁿ⁻² of switching modules to which all switching modules of level A are connected and the number of switches in each further switching module is lower by a factor of 2.

Moreover, there are possible yet further embodiments, wherein the switching module levels are switched in different sequences, wherein the levels are not switched in a consecutive manner (e.g., a switching sequence of A, C, B, D)—in any case, the more switching modules are configured to the series connection, the higher will be the driving voltage.

Therefore, if the topology of FIG. 2A is applied for 128 cell modules (2⁷), level A of switching modules has 64 switching modules, level B has 32 switching modules, level C has 16 switching modules, level D has 8 switching modules, level E has 4 switching modules, level F has 2 switching modules, level G has 1 switching module. The switching modules can be switched to provide sequentially higher driving voltage levels in a sequence from A to G (in a manner equivalent to that shown in FIGS. 3A-3D) or from G to A (in a manner equivalent to that shown in FIGS. 4A-4D).

FIG. 2B shows a second variant of the first example embodiment. It differs from the first variant shown in FIG. 2A in that a Single Pole Single Throw (SPST) switch 121A is used in place of the SPDT switch 121, then its input terminal is connected to the first terminal T1 of the first terminals pair and its output terminal is connected to the first terminal T3 of the second terminals pair. When the SPDT switch 122 is set to the first position, the SPST switch 121A is set to a closed position, and when the SPDT switch 122 is set to the second position, the SPST switch 121A is set to an open position.

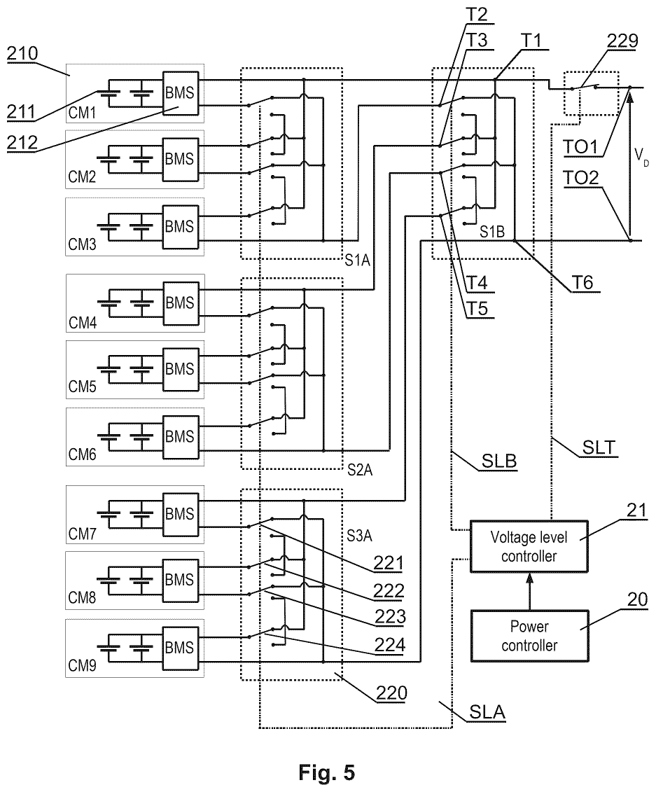

FIG. 5 shows a second example embodiment of a topology of a configurable battery for providing the driving voltage at different voltage levels; The configurable battery 10 of this embodiment comprises nine cell modules 210 (CM1-CM8), each cell module 210 comprising three cells 211 connected in parallel that may be controlled by a battery management system (BMS) 212. The cell modules 210 are connected to a cascade of switching modules 220 (S1A-S3A, S1B), wherein each of the switching modules comprises four switches 221, 222, 223, 224, and to a terminating switch 229. The switches 221, 222, 223, 224, 229 form a role of connectors that connect the cell modules 210 to form a battery to generate the driving voltage. The position of the switches 221, 222, 223, 224, 229 is controlled by a voltage level controller 21 that operates in response to the signal from the power controller 20 to provide the driving voltage at one of a set of selectable four voltage levels.

The switching modules 220 have six terminals T1-T6. The switching modules 220 are designed to selectably connect three pairs of input terminals (the first pair: T1, T2, the second pair: T3, T4 and the third pair: T5, T6) into a series connection or a parallel connection, such as to provide an output terminal pair. The switches 221, 222, 223, 224 are Single Pole Double Throw (SPDT) switches, i.e., they have one input terminal and two output terminals. For the first switch 221, its input terminal is connected to the second terminal T2 of the first terminals pair, its first output terminal is connected to the second terminal T6 of the third terminals pair, and its second output terminal is connected to the second output terminal of the second switch 222. For the second switch 222, its input terminal is connected to the first terminal T3 of the second terminals pair, its first output terminal is connected to the first terminal T1 of the first terminals pair, and its second output terminal is connected to the second output terminal of the first switch 221. For the third switch 223, its input terminal is connected to the second terminal T4 of the second terminals pair, its first output terminal is connected to the second terminal T6 of the third terminals pair, and its second output terminal is connected to the second output terminal of the fourth switch 224. For the fourth switch 224, its input terminal is connected to the first terminal T5 of the third terminals pair, its first output terminal is connected to the first terminal T1 of the first terminals pair, and its second output terminal is connected to the second output terminal of the third switch 223. When the switches 221, 222, 223, 224 are all set into their first position (i.e., connecting the input to the first output), the pairs of terminals T1, T2; T3, T4; T5, T6 are connected in parallel with each other. When the switches 221, 222, 223, 224 are all set into their second position (i.e., connecting the input to the second output), the pairs of terminals T1, T2; T3, T4; T5, T6 are connected in series with each other.

Each switching module S1A-S3A, S1B is therefore connected to three input terminal pairs T1, T2; T3, T4; T5, T6 and provides an output terminal pair T1, T6. The switching modules are connected in a cascade, wherein the first level A of three switches S1A-S3A is connected to nine cell modules CM1-CM9 and provides three output pairs, the second level B including the switch S1B provides one output pair.

All switches 221-224 within all modules 220 of the same level A, B are at a given time set to the same position. The position of the switches 221-224 of modules 220 within a particular level A, B is controlled by a corresponding control signal SLA, SLB from the voltage level controller 21. The position of the terminating switch 229 is controlled by a control signal SLT. The switch 229 is an SPST switch, it has its input terminal connected to a first output terminal of the output pair of the second level B and its output terminal providing an output voltage in a closed position.

The output of the configurable battery is therefore provided as a pair of terminals, wherein the first output terminal TO1 is connected to the output terminal of the switch 229 and the second output terminal T02 is connected to the second output terminal of the second level B of switch modules.

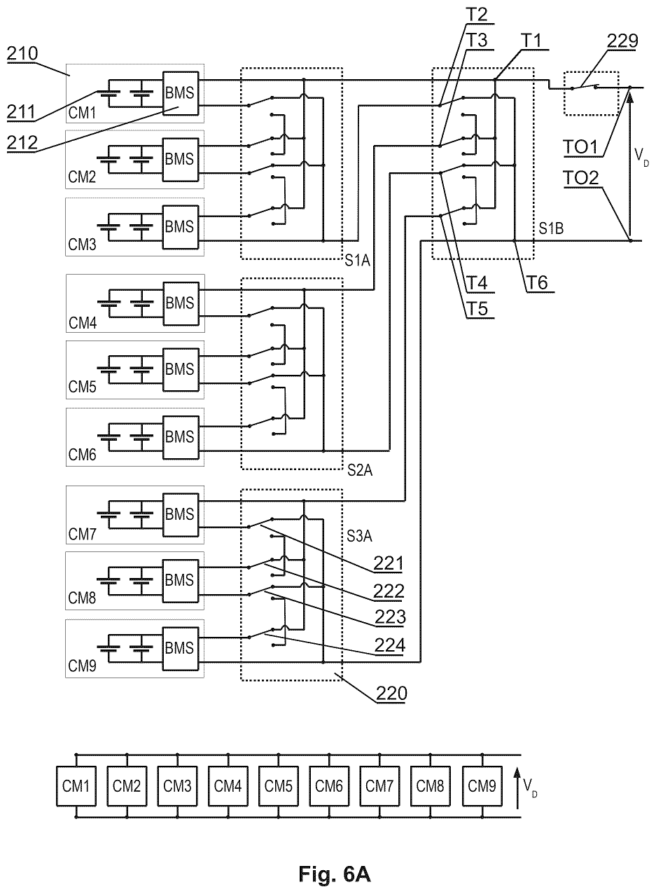

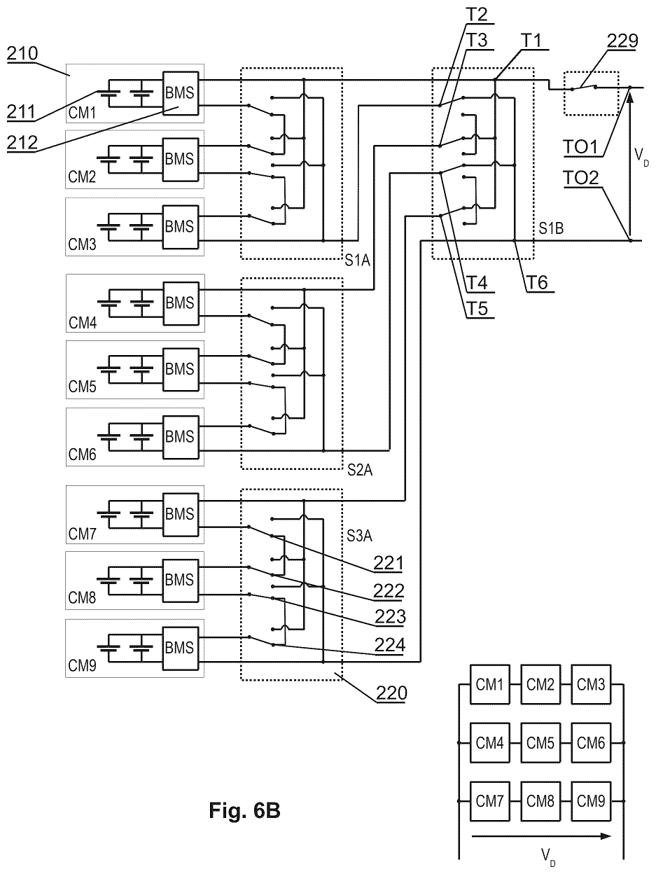

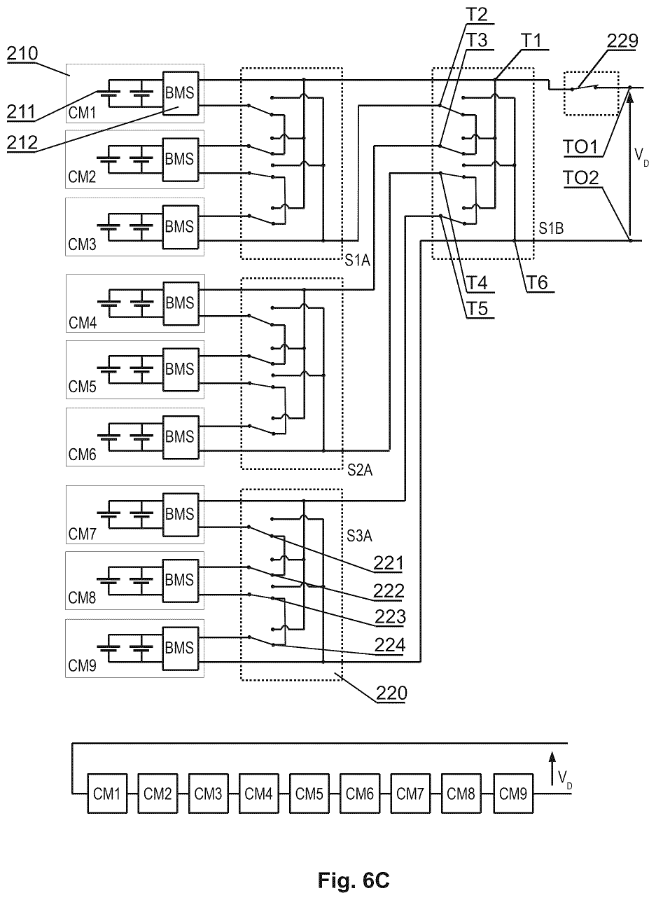

Depending on the desired configuration of clusters, the topology of FIG. 5 can be setup into different configurations, some examples of which are provided on FIGS. 6A-6D.

Assume each cell module provides the same output voltage designated as V_{CM}.

In the example of FIGS. 6A-6C, the switches at levels A-B are switched in the order A->B, which gives the following configurations.

First, in order to switch on the power supply and provide the lowest voltage level, all switches 221-224 of all switching modules are set to the first position and the switch 229 is set to the closed position, as shown in FIG. 6A (when the switch 229 would be set to the open position, there would be no output voltage provided). In such configuration, all cell modules CM1-CM9 are connected in parallel and the driving voltage V_{D}=V_{CM}. In other words, the cell modules CM1-CM9 form nine clusters connected in parallel, each cluster containing a single cell module. The electric current drawn from each cell module CM1-CM9 is 1/9 of the total current drawn from the battery.

Next, in order to provide a higher voltage level, the switching modules S1A-S3A of level A are switched to the second position, as shown in FIG. 6B. In such configuration, the cell modules CM1-CM9 form three clusters connected in parallel, wherein each cluster contains three cell modules connected in series: CM1, CM2, CM3; CM4, CM5, CM6; CM7, CM8, CM9. The driving voltage V_{D}=3*V_{CM}. The electric current drawn from each cell module CM1-CM9 is ⅓ of the total current drawn from the battery.

Next, in order to provide a higher voltage level, the switching module S1B of level B is switched to the second position, as shown in FIG. 6C. In such configuration, the cell modules CM1-CM9 form a single cluster, which contains nine cell modules connected in series: CM1-CM9. The driving voltage V_{D}=9*V_{CM}. The electric current drawn from each cell module CM1-CM9 is the total current drawn from the battery.

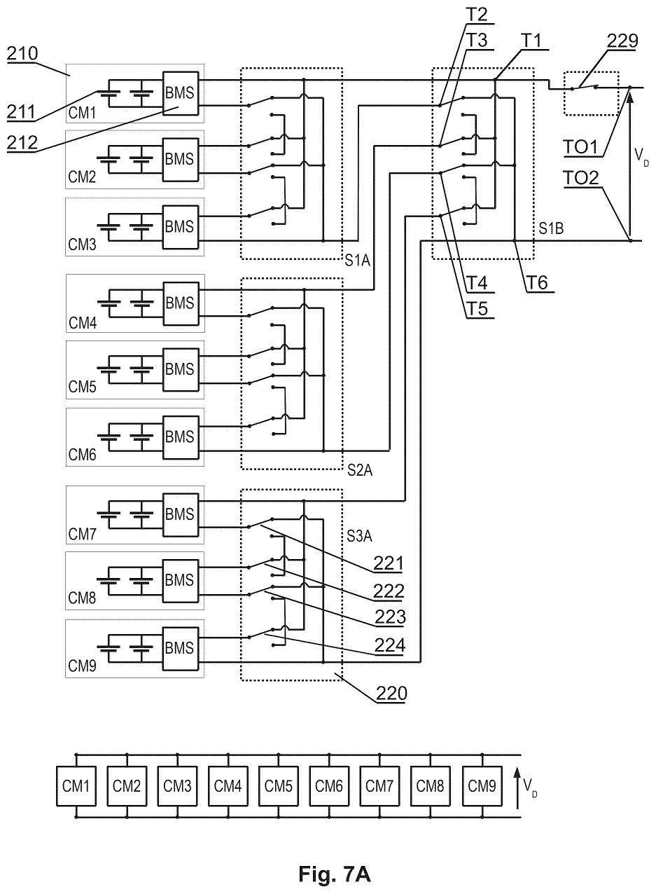

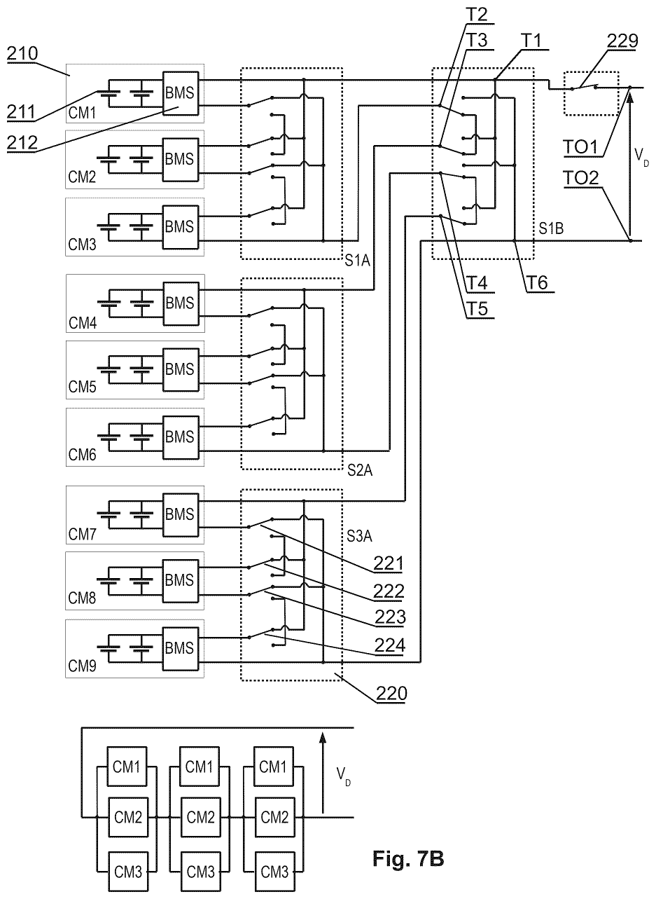

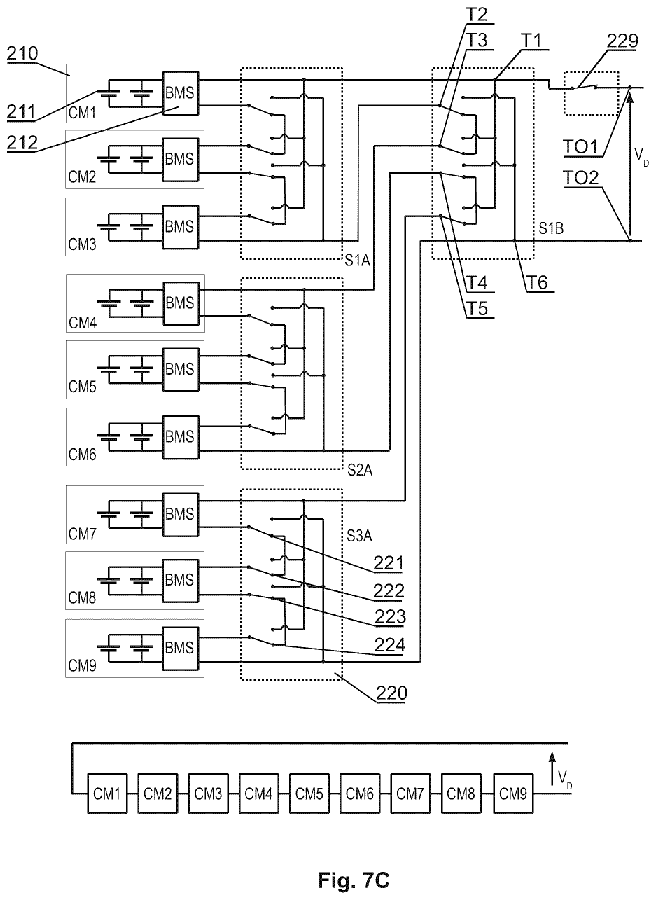

In the example of FIGS. 7A-7C, the switches at levels A-B are switched in the order B->A, which gives the following configurations.

First, in order to switch on the power supply and provide the lowest voltage level, all switches 221-224 of all switching modules are set to the first position and the switch 229 is set to the closed position, as shown in FIG. 7A (when the switch 229 would be set to the open position, there would be no output voltage provided). In such configuration, all cell modules CM1-CM9 are connected in parallel and the driving voltage V_{D}=V_{CM}. In other words, the cell modules CM1-CM9 form a single cluster that contains nine cell modules connected in parallel. The electric current drawn from each cell module CM1-CM9 is 1/9 of the total current drawn from the battery.

Next, in order to provide a higher voltage level, the switching module S1B of level B is switched to the second position, as shown in FIG. 7B. In such configuration, the cell modules CM1-CM9 form three clusters connected in series, wherein each cluster contains three cell modules connected in parallel: CM1, CM2, CM3; CM4, CM5, CM6; CM7, CM8, CM9. The driving voltage V_{D}=3*V_{CM}. The electric current drawn from each cell module CM1-CM9 is ⅓ of the total current drawn from the battery.

Next, in order to provide a higher voltage level, the switching modules S1A-S1C of level A are switched to the second position, as shown in FIG. 7C. In such configuration, the cell modules CM1-CM9 form nine clusters connected in series, wherein each cluster contains a single module. The driving voltage V_{D}=9*V_{CM}. The electric current drawn from each cell module CM1-CM9 is the total current drawn from the battery.

The configurable battery of the topology of FIG. 5 can provide three different voltage output levels from nine cell modules.

In general, the system of the topology of FIG. 5 can provide n+1 different voltage output levels from 3ⁿ cell modules by using n levels of switching modules and the terminating switch, wherein n=2 in this example. The first level A of switching modules contains 3ⁿ⁻¹ of switching modules to which all cell modules are connected, the second level B of switching modules contains 3ⁿ⁻² of switching modules to which all switching modules of level A are connected and the number of switches in each further switching module is lower by a factor of 3.

Therefore, if the topology of FIG. 5 is applied for 243 cell modules (2⁵), level A of switching modules has 81 switching modules, level B has 27 switching modules, level C has 9 switching modules, level D has 3 switching modules, level E has 1 switching module. The switching modules can be switched to provide sequentially higher driving voltage levels in a sequence from A to E (in a manner equivalent to that shown in FIGS. 6A-6C) or from E to A (in a manner equivalent to that shown in FIGS. 7A-7C) or other sequences.

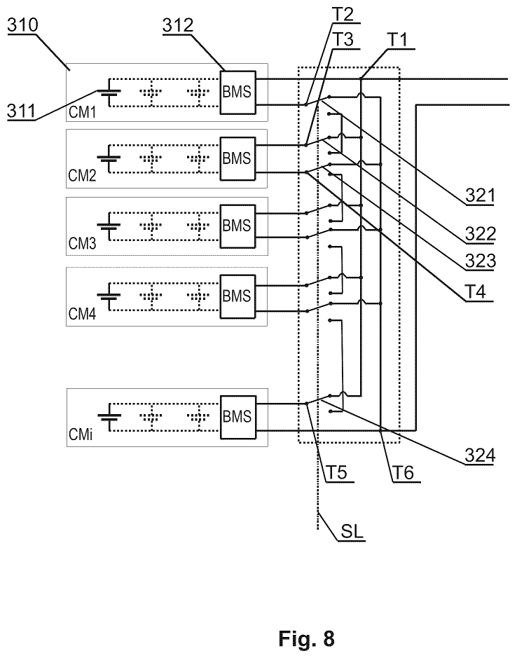

FIG. 8 shows a third example embodiment of a fragment of a topology a configurable battery for providing the driving voltage at different voltage levels.

This is a generalized embodiment, wherein the configurable battery 10 comprise iⁿ cell modules, wherein n is the number of switching modules and i is the number of input pairs to each module. The system can provide n+1 different voltage output levels from iⁿ cell modules by using n levels of switching modules and the terminating switch. The first level of switching modules contains iⁿ⁻¹ of switching modules to which all cell modules are connected, the second level of switching modules contains iⁿ⁻² of switching modules to which all switching modules of the preceding level are connected and the number of switches in each further switching module is lower by a factor of i.

In FIG. 8, a topology of the switching module is presented, which can be applied to any value of i in a manner similar to that shown in FIG. 5. The switching module contains iⁿ cell modules 310 (CM1-CMiⁿ), each cell module 310 comprising one or more cells 311 connected in parallel that may be controlled by a battery management system (BMS) 312. The cell modules 310 are connected to a cascade of switching modules 320, wherein each of the switching modules comprises 2*i−2 switches 321, 322, 323, 324, and to a terminating switch (not shown in FIG. 8, to be positioned as in FIG. 5). The switches 321, 322, 323, 324 form a role of connectors that connect the cell modules 310 to form a battery to generate the driving voltage. The position of the switches 321, 322, 323, 324 is controlled by a voltage level controller 21 that operates in response to the signal from the power controller 20 to provide the driving voltage at one of a set of selectable four voltage levels.

The switching modules 320 have 2*i terminals T1-T6. The switching modules 320 are designed to selectably connect i pairs of input terminals into a series connection or a parallel connection, such as to provide an output terminal pair. The switches are Single Pole Double Throw (SPDT) switches, i.e., they have one input terminal and two output terminals. For the first switch 321, its input terminal is connected to the second terminal T2 of the first terminals pair, its first output terminal is connected to the second terminal T6 of the last terminals pair, and its second output terminal is connected to the second output terminal of the second switch 322. For the second switch 322, its input terminal is connected to the first terminal T3 of the second terminals pair, its first output terminal is connected to the first terminal T1 of the first terminals pair, and its second output terminal is connected to the second output terminal of the first switch 321. For the third switch 323, its input terminal is connected to the second terminal T4 of the second terminals pair, its first output terminal is connected to the second terminal T6 of the last terminals pair, and its second output terminal is connected to the second output terminal of the following switch. The configuration of each further even-numbered (apart from the last one) and odd-numbered switch corresponds to the configuration of the second switch 322 and the third switch 323. For the last switch 324, its input terminal is connected to the first terminal T5 of the last terminals pair, its first output terminal is connected to the first terminal T1 of the first terminals pair, and its second output terminal is connected to the second output terminal of a preceding switch. When the switches 321, 322, 323, 324 are all set into their first position (i.e., connecting the input to the first output), the pairs of terminals T1, T2; T3, T4; T5, T6 are connected in parallel with each other. When the switches 321, 322, 323, 324 are all set into their second position (i.e., connecting the input to the second output), the pairs of terminals T1, T2; T3, T4; T5, T6 are connected in series with each other.

Each of such switching modules is therefore connected to i input terminal pairs T1, T2; T3, T4; T5, T6 and provides an output terminal pair T1, T6. The switching modules can be connected in a cascade, wherein the first level of iⁿ⁻¹ switching modules is connected to iⁿ cell modules and provides iⁿ⁻² output pairs.

All switches 321-324 within the module 320 are at a given time set to the same position, according to a control signal SL from the voltage level controller 21.

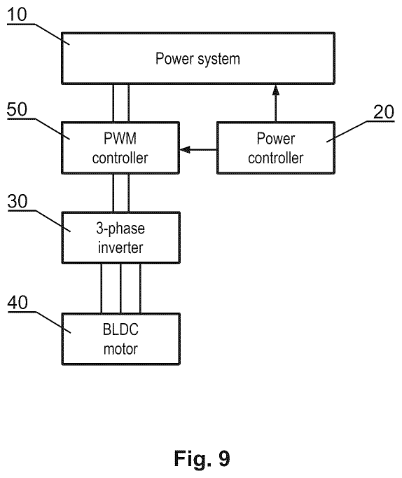

FIG. 9 shows an overall diagram of a second embodiment of a system for driving a direct current motor. A configurable battery 10 provides a driving voltage of different levels that depend on a power controller 20 which is in turn controlled by a gas pedal or a cruise control system of the vehicle. The driving voltage is input to a pulse-width modulation (PWM) controller 50 that is also controlled by the power controller 20 to allow precise control of the voltage value. The output of the PWM converter 50 is input to a 3-phase inverter 30 that drives a direct current (DC) electric motor 40, such as a brushless direct current (BLDC) motor. For example, the configurable battery 10 can provide voltage supply at 8 different levels, from a topology such as shown in FIG. 2A, wherein individual cell modules provide 3.7V output and there are 8 voltage levels (level 1=3.7V, level 2=7.4 V, level 3=14.8 V, level 4=29.6 V, level 5=59.2 V, level 6=118.4 V, level 7=236.8 V, level 8=473.6 V). The PWM controller can be used to adjust the voltage to a precise value between the levels. In that case, the power controller 20 determines the desired voltage level and for example for a desired voltage level of 22.2 V, the configurable battery 10 will be configured to provide voltage output of level 4 (29.6V) and the PWM controller 50 will be setup to provide 75% pulse width. In that case, the PWM pulses will be typically over 50% length, because a voltage resulting from a shorter than 50% pulse width can be better achieved by switching the configurable battery 10 to a lower voltage level (although the system, for some special purposes, can be also designed to allow pulse widths of less than 50%, for example to 25% such as to limit the amount of switching of the configurable battery 10). In that embodiment, the voltage level can be controlled as precisely as in typical PWM systems, but the load to the cell modules is limited, because for voltage levels lower than the highest level the cells are connected in parallel configurations. Moreover, the PWM controller switches lower voltages (apart from operating at highest voltage level provided by the configurable battery 10). All of this leads to substantial heat reduction and more balanced load to the cells as compared to the typical PWM system wherein the maximum battery voltage is always provided for switching.

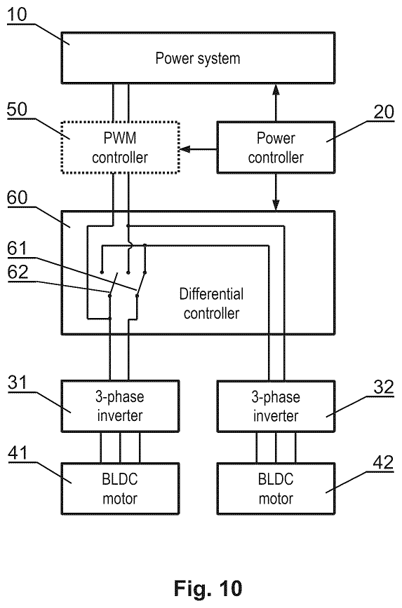

FIG. 10 shows an overall diagram of a third embodiment of a system for driving a direct current motor. A configurable battery 10 provides a driving voltage of different levels that depend on a power controller 20 which is in turn controlled by a gas pedal or a cruise control system of the vehicle. The driving voltage can be input to a pulse-width modulation (PWM) controller 50 that is also controlled by the power controller 20 to allow precise control of the voltage value. The output of the configurable battery 10 or of the PWM converter 50 is input to a differential controller 60 that provides power to 3-phase inverters 31, 32, each of which provides power to a direct current (DC) electric motor 41, 42, such as a brushless direct current (BLDC) motor.

The differential controller 60 comprises a pair of switches 61, 62 that can be set to a first configuration (as shown in FIG. 10) wherein the 3-phase inverters 31, 32 are connected in series to the output of the power system 10 (or of the PWM controller 50) and to a second configuration (by switching both switches 61, 62 to their second state) wherein the 3-phase inverters 31, 32 are connected in parallel to the output of the power system 10 (or of the PWM controller 50).

In particular, the switches 61, 62 are Single Pole Double Throw (SPDT) switches, i.e., they have two input terminals and one output terminal. For the first switch 61, its first input terminal is connected to a second input terminal of the second switch 62 and to a first input of the second 3-phase converter 32, its second input terminal is connected to an isolated point, and its output is connected to a first output of the power system 10 (or of the PWM converter 50) and to a first input of the first 3-phase converter 31. For the second switch 62, its first input terminal is connected to the second output of the power system 10 (or of the PWM converter 50) and to a second input of the 3-phase inverter 32, its second input terminal is connected to the first input terminal of the first switch 61 and to the first input of the second 3-phase converter 32, and its output is connected to a second input of the first 3-phase converter 31.

In the first configuration, wherein the 3-phase inverters 31, 32 are connected in series, in normal driving condition both motors 41, 42 receive half of the driving voltage output from the power system 10 (or the PWM converter 50). If the resistance of one of the motors, e.g., 41, decreases (e.g., when taking a turn, a wheel of a vehicle driven by that motor runs along the internal curve of the turn), the voltage at that motor 41 will decrease, while the voltage at the other motor 42 will increase. This way, such system operates in a manner similar to a mechanical differential, which accelerates one of the wheels if another wheel decelerates.

In the second configuration, wherein the 3-phase inverters 31, 32 are connected in parallel, both motors 41, 42 receive the full driving voltage output from the power system 10 (or the PWM converter 50). This way, such system operates in a manner similar to a mechanical limited slip differential (LSD).

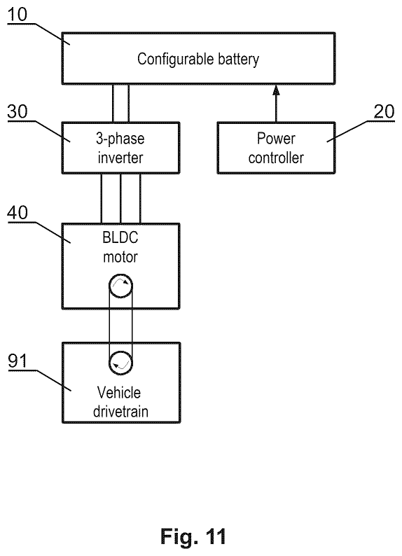

The configuration of the switches 61, 62 can be set by means of an LSD controller 63 by means of which a user of the vehicle may activate or deactivate the limited slip functionality. Furthermore, the configuration of the switches 61, 62 can be set by means of the power controller 20, such that the limited slip functionality is activated when the highest voltage is generated (so that both motors can receive the full voltage output from the power system). FIG. 11 shows an embodiment of application of the power system of FIG. 1. The power system is connected to a drivetrain 91 comprising components that deliver power from the electric motor 40 to wheels of the vehicle. The components of the drivetrain 91 may include a transmission, such as a CVT transmission, to control of speed of wheels even if the power system provides stepped voltage to the motor, without the need to use PWM. Moreover, the drivetrain 91 may comprise a set of reduction gears, a manual transmission or an automatic transmission of two or more gears. In case of use of a single electric motor, the drivetrain shall comprise a standard mechanical differential. Such set of components forms therefore a powertrain in a vehicle, such as a car.

The battery cells 111, 211, 311 can be of various types, for example accumulator cells such as lithium batteries or fuel cells such as hydrogen fuel cells.

The switches 121, 121A, 122, 129, 221, 222, 229, 321, 322, 329 can be realized by means of any switching devices, for example by power transistors or MOSFET transistors, which can be formed as an integrated circuit and the switching circuit can be integrated with the battery.

The power system of the invention can be used for various vehicles, such as electric-driven cars, motorbikes, trucks, buses, heavy duty machinery, scooters, hoverboards, motorboats, jet skis, airborne ships, drones, helicopters etc.

While the invention has been described with respect to a limited number of embodiments, it will be appreciated that many variations, modifications and other applications of the invention may be made. Therefore, the claimed invention as recited in the claims that follow is not limited to the embodiments described herein.

1. A power system for driving a direct current electric motor of a vehicle that is controlled by a driving voltage, the power system comprising:
a plurality of cell modules, each cell module comprising one or more cells;
a plurality of connectors for connecting the cell modules to form a configurable battery to generate the driving voltage;
wherein the connectors are configured to connect the cell modules into configurable clusters; and
a voltage level controller configured to control the configuration of the configurable clusters to provide the driving voltage at one of a set of voltage levels, wherein for each voltage level of said set a ratio of a current drawn from each of the cell modules a total current drawn from the configurable battery is lower than for each higher voltage level of said set;
wherein the voltage level of the driving voltage is selectable in by means of a power controller controlled by a gas pedal or a cruise control system of the vehicle; and
wherein each of the plurality of cell modules further comprises a dedicated battery management system configured to protect said one or more cells of that cell module from operating outside a safe operating range, wherein the operating range is defined between a lowermost voltage value and an uppermost voltage value and the battery management system is configured to protect said one or more cells of that cell module from charging over the uppermost voltage value and discharging below the lowermost voltage value.

2. The system according to claim 1, wherein the connectors are configured to connect the cell modules into one or more clusters connected in parallel, wherein each cluster comprises one or more cell modules connected in series and for each voltage level of said set the number of cell modules in each cluster is lower than for each higher voltage level of said set.

3. The power system of claim 1, wherein for a driving voltage lower than the highest possible voltage, at least two clusters are connected in parallel.

4. The power system of claim 1, wherein the connectors are configured to connect the cell modules into one or more clusters connected in series, wherein each cluster comprises one or more cell modules connected in parallel and for each voltage level of said set the number of cell modules in each cluster is higher than for each higher voltage level of said set.

5. The power system of claim 1, wherein for a driving voltage lower than the highest possible voltage, each cluster contains at least two cells.

6. The power system of claim 1, wherein at least a majority of all of the cell modules are always actively connected within the clusters that provide the driving voltage.

7. The power system of claim 1, further comprising a pulse width modulation controller for providing the driving voltage to the motor as a series of controlled-width pulses having an amplitude according to the output voltage level.

8. The system of claim 1, further configured to supply the driving voltage of the highest level to two motors connected in parallel and to supply the driving voltage of half of the highest level or less to two motors connected in series.

9. A powertrain comprising the power system of claim 1 connected to at least one electric motor and a drivetrain for delivering mechanical power from the at least one electric motor to wheels.

10. The powertrain of claim 9, wherein the drivetrain comprises a continuously variable transmission.

11. The powertrain of claim 9, comprising a pair of electric motors configured to drive a pair of wheels of a vehicle axis and a differential controller configured to be set:
in a first configuration to connect the electric motors in series to the voltage output from the power system to provide a mechanical differential functionality;
in a second configuration to connect the electric motors in parallel to the voltage output from the power system to provide a limited slip differential functionality.
